(19) United States
(12) Patent Application Publication
(10) Pub. No.: US 2008/0276487 A1
(43) Pub. Date: Nov. 13, 2008

(54) DRYING APPARATUS

(75) Inventors: GUANG-DONG YUAN, Shenzhen (CN); CHUNG-CHI HUANG, Tu-Cheng (TW); XIAN-MING WANG, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/959,472

(22) Filed: Dec. 19, 2007

(30) Foreign Application Priority Data
May 10, 2007 (CN) 200710200596.X

(51) Int. Cl. F26B 21/08

(52) U.S. Cl. 34/524

(57) ABSTRACT

A drying apparatus includes a humidity sensor module, a micro control unit (MCU) module, an indicator circuit, and a fan module. The humidity sensor module measures relative humidity of air in a computer, and converts that measurement to an electronic signal. The MCU module receives the electronic signal from the humidity sensor module, and respectively outputs an indication signal and a control signal when the measured humidity is greater than a predetermined value stored in the MCU module. The indicator circuit indicates the humidity in the computer is too high when it receives the indication signal from the MCU module. The fan is activated when it receives the control signal from the MCU module.

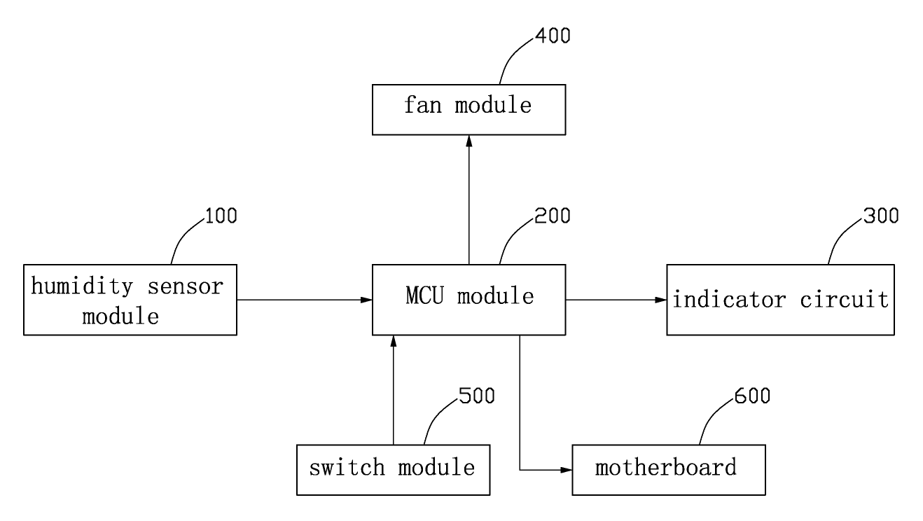

### BACKGROUND OF THE INVENTION

1. Field of the Invention

The present invention relates to drying apparatuses which can measure relative humidity of air inside a computer, and activate a fan for drying the inside of the computer when the humidity exceeds a predetermined value.

2. Description of Related Art

Electronic components on a motherboard of a computer can be sensitive to given levels of moisture in their immediate environment, they may corrode or otherwise be degraded by excessive moisture. Additionally, excessive moisture may create a lot of static electricity and influence the reliability of the computer.

What is needed, therefore, is to provide a drying apparatus which can measure relative humidity of air in a computer, and activate a fan for drying the inside of the computer when the humidity exceeds a predetermined value.

### SUMMARY OF THE INVENTION

An exemplary drying apparatus includes a humidity sensor module, a micro control unit (MCU) module, an indicator circuit, and a fan module. The humidity sensor module measures relative humidity of air in a computer, and converts that measurement to an electronic signal. The MCU module receives the electronic signal from the humidity sensor module, and respectively outputs an indication signal and a control signal when the measured humidity is greater than a predetermined value stored in the MCU module. The indicator circuit indicates the humidity in the computer is too high when it receives the indication signal from the MCU module. The fan is activated when it receives the control signal from the MCU module.

Other advantages and novel features of the present invention will become more apparent from the following detailed description of preferred embodiment when taken in conjunction with the accompanying drawing, in which:

### BRIEF DESCRIPTION OF THE DRAWING

The drawing is a block diagram of an embodiment of a drying apparatus in accordance with the present invention.

### DETAILED DESCRIPTION OF THE INVENTION

Referring to the drawing, a drying apparatus in accordance with an embodiment of the present invention includes a humidity sensor module 100, a micro control unit (MCU) module 200, an indicator circuit 300, a fan module 400, and a switch module 500. The humidity sensor module 100 measures humidity of air in a computer, and converts the humidity of air to an electronic signal. The MCU module 200 receives the electronic signal from the humidity sensor module 100, and respectively outputs an indication signal and a control signal when the measured humidity is greater than a predetermined value stored in the MCU module 200. The indicator circuit 300 indicates the humidity of air in the computer is too high when it receives the indication signal from the MCU module 200. The fan module 400 is activated when it receives the control signal from the MCU module 200. The switch module 500 is coupled to the MCU module 200, and is configured to reset the MCU module 200.

The drying apparatus is disposed on a motherboard 600 of the computer, and is powered by the motherboard 600. When the computer starts, the drying apparatus is powered up. The sensor module 100 measures the relative humidity of air in the computer and converts that measurement to an electronic signal, and then transmits the electronic signal to the MCU module 200. The MCU module 200 compares the measured humidity with the predetermined value, and respectively outputs an indication signal and a control signal when the humidity value is greater than the predetermined value. The indicator circuit 300 emits light or makes a sound to indicate the relative humidity of air in the computer is too high when it receives the indication signal. The fan module 400 rotates to increase airflow around the motherboard 600 to aid in evaporation of the moisture therearound when it receives the control signal. When the humidity of the air in the computer falls below the predetermined value, users can press the switch module 500 to send a reset signal to the MCU module 200. The MCU module 200 resets and stops outputting the indication signal and control signal. The indicator circuit 300 stops emitting light or making sound, and the fan 400 stops rotating. Then the MCU module 200 outputs a boot signal to a south bridge on the motherboard 600 to start the computer. In this embodiment, the MCU module 200 can be set as auto resetting. When the humidity value in the computer is less than the predetermined value, the MCU module 200 resets automatically and outputs the boot signal to start the computer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A drying apparatus, comprising:
a humidity sensor module configured for measuring relative humidity of air in a computer, and converting that measurement to an electronic signal;
a micro control unit (MCU) module configured for receiving the electronic signal from the humidity sensor module, and respectively outputting an indication signal and a control signal when the measured humidity is greater than a predetermined value stored in the MCU module;
an indicator circuit configured for indicating the humidity in the computer is too high when it receives the indication signal from the MCU module; and
a fan module configured for rotating when it receives the control signal from the MCU module.

2. The drying apparatus as claimed in claim 1, further comprising a switch module coupled to the MCU module, the switch module is configured to reset the MCU module.

3. A drying apparatus assembly, comprising:
a humidity sensor module configured for measuring relative humidity of air in a computer, and converting that measurement to an electronic signal;
a micro control unit (MCU) module configured for receiving the electronic signal from the humidity sensor module, and respectively outputting an indication signal and a control signal when the measured humidity is greater than a predetermined value stored in the MCU module;
an indicator circuit configured for indicating the humidity in the computer is too high when it receives the indication signal from the MCU module;
a fan module configured for rotating when it receives the control signal from the MCU module; and
a motherboard with a south bridge coupled to the MCU module, when the measured humidity is less than the predetermined value, the MCU module outputs a boot signal to the south bridge to start the computer.

4. The drying apparatus assembly as claimed in claim 3, further comprising a switch module coupled to the MCU module, the switch module is configured to reset the MCU module.
